(19) United States
(12) Patent Application Publication
(10) Pub. No.: US 2018/0375097 A1
(43) Pub. Date: Dec. 27, 2018

(54) SPINEL MATERIAL

(71) Applicant: CSIR, Pretoria (ZA)

(72) Inventors: Kenneth Ikechukwu Ozoemena, Pretoria (ZA); Kumar Raju, Pretoria (ZA)

(73) Assignee: CSIR, Pretoria (ZA)

(21) Appl. No.: 16/064,241

(22) PCT Filed: Dec. 14, 2016
(86) PCT No.: PCT/IB2016/057611

§ 371 Date: Jun. 20, 2018

(30) Foreign Application Priority Data
Dec. 22, 2015 (ZA) 2015/09296

(51) Int. Cl. H01M 4/525; H01M 10/0525; H01M 4/505; C01G 53/00; H01M 4/1391

(52) U.S. Cl. CPC H01M 4/525; H01M 10/0525; H01M 4/505; C01G 53/54; H01M 4/1391; C01P 2006/40; C01P 2002/52; C01P 2002/72; C01P 2002/76; C01P 2004/03; C01P 2004/04; C01P 2002/32

(57) ABSTRACT

A process for producing a doped lithium manganese-oxide spinel material includes producing, by means of a solid-state reaction, a spinel precursor comprising lithium-manganese-oxide doped with nickel. The precursor is subjected to microwave treatment, to obtain a treated precursor. The treated precursor is annealed to obtain a nickel-doped lithium-manganese-oxide spinel material.

THIS INVENTION relates to a spinel material. It relates in particular to a process for producing a spinel material, to an electrochemical cell containing the spinel material, to a method of making the electrochemical cell, and to a method of operating the electrochemical cell.

Rechargeable lithium-ion batteries (RLIBs) have emerged as the most dominant power sources for portable electronics and electric vehicles, and will remain so for many years to come. Spinel, layered and olivine materials are the most important cathode materials for the RLIBs. Manganese-based spinel materials have, over time, become more attractive due to their inherent advantageous properties such as earth-abundance, low-cost, environmental benignity and satisfactory thermal stability. Lithium manganese oxide, LiMn₂O₄ (LMO) spinel cathode material for RLIBs is the cathode material that drives some electric vehicles. Two main challenges that still confront this cathode material are (i) a disproportionation reaction and (ii) Jahn-Teller effects, especially at elevated temperatures (about 55° C. and higher). Indeed, the LMO combined with its robust spinel framework exhibits an astonishing cycle life associated with substantial capacity retention at room temperature. However, LMO suffers, at elevated temperatures, from rapid capacity fading with cycling due to manganese dissolution which limits the practical use of this material for large-scale applications. In particular, the Mn-dissolution arises from the disproportionate reaction of Mn³⁺ ions into Mn²⁺ and Mn⁴⁺ ions, with Mn²⁺ dissolution into the electrolyte which then gets deposited as metal on the surface of the negative electrode, and Mn⁴⁺ being involved in promoting the electro-inactive layer on the positive side that could create defects in the lattice. To alleviate these problems that cause capacity fading, surface-coating with metal oxides and partial substitution of Mn ions with other metal ions to reduce Mn³⁺ that could partially minimize the Mn-dissolution and improve cycle retention to some extent, have been proposed. It has been reported that when the core-shell structure of LMO is decorated with a nickel-doped LMO (LMNO) shell, extensive cycle stability at 60° C. is experienced; however, this involves an expensive method for the preparation of the material. On the other hand, the surface modification of electrode materials can also pave the way to improve the stability, for instance, the excellent performance of octahedral LMO with its surface facets, especially {111} which allows thinner solid electrolyte interphase (SEI) formation than {110} facets, has been demonstrated. It is well established that the poor electrochemical performance of the LMO at elevated temperature stems from the instability of the Mn³⁺ by its disproportionation to Mn²⁺ and Mn⁴⁺, and the subsequent fast dissolution of the divalent species and the creation of lattice defects within the structure. Also, the Mn³⁺-rich disordered form of high-voltage nickel-doped LMO (i.e., LiMn_{1.5}Ni_{0.5}O_{4-δ}) is known to show better electrochemical performance at elevated temperature (60° C.) than its Mn⁴⁺-rich ordered counterpart (i.e., LiMn_{1.5}Ni_{0.5}O₄). LMO chemistry can be improved by doping with very small amount of the nickel, e.g., LiNi_{0.2}Mn_{1.8}O₄. Besides, strengthening the [MnO₆] octahedron is critical to restrain the Jahn-Teller effect and to avoid partial Ni occupation of the Li 8a sites by optimizing the Ni content; this is achieved with the highly stable spinel stoichiometry is LiMn_{1.8}Ni_{0.2}O₄.

According to a first aspect of the invention, there is provided a process for producing a doped lithium-manganese-oxide spinel material, which process includes
producing, by means of a solid-state reaction, a spinel precursor comprising lithium-manganese-oxide doped with nickel;
subjecting the precursor to microwave treatment, to obtain a treated precursor; and
annealing the treated precursor, to obtain a nickel-doped lithium-manganese-oxide spinel material.

The solid state reaction may include heating a mixture of a solid manganese precursor material, a solid nickel precursor material, a solid lithium precursor material and a fuel or reducing agent to an elevated temperature, and maintaining it at the elevated temperature for a period of time.

By ‘solid’ is meant that the reactants are in a non-liquid form, e.g. in a solid particulate or powdered form.

The solid manganese precursor material may be an oxide, a hydroxide or a salt of manganese, e.g. Mn₃O₄; the solid nickel precursor material may be an oxide, a hydroxide or a salt of nickel, e.g. NiO; the solid lithium precursor material may be an oxide, a hydroxide or a salt of lithium, e.g. Li₂CO₃; and the fuel or reducing agent may be urea, hydrazine, glycine, a carbohydrate such as sucrose, etc; however, a solid fuel such as urea is preferred.

If necessary, the mixture may be comminuted to render it into particulate, e.g. powdered, form, before it is heated.

The reactants may be used in molar amounts to produce the desired spinel material; however, an excess, e.g. a 10% excess, of Li₂CO₃ may be used to compensate for less thereof at elevated temperatures.

The elevated temperature to which the mixture is heated may be at least 400° C., preferably about 500° C.

The period of time for which the mixture is maintained at the elevated temperature may be at least 5 minutes, preferably about 7 minutes.

The microwave treatment may comprise subjecting the precursor to microwaves for between 10 and 30 minutes, typically for about 20 minutes. The microwaves may typically be at λ=0.12236, with the microwave power during the treatment being about 600 W. However, the microwave power may be less than or greater than 600 W.

The annealing of the treated precursor will be effected at a temperature which is sufficiently high to crystallize the precursor. Thus the annealing may be effected at a temperature of at least 700° C., more preferably at about 800° C. or higher, most preferably at about 900° C. The annealing may be effected for a period of time which is long enough to achieve a desired degree of annealing, i.e. to achieve a desired degree of crystallinity of the powder. Typically, the annealing time will be less than 12 hours, e.g. about 6 hours.

The nickel-doped lithium-manganese-oxide material is thus that obtained by means of a microwave assisted solid state reaction process.

The lithium-manganese-oxide material may be LiMn₂O₄ (‘LMO’), while the nickel-doped lithium-manganese-oxide material is LiMn_{1.8}Ni_{0.2}O₄ (‘LMNO’).

The invention extends to a nickel-doped lithium-manganese-oxide spinel material when produced by the process of the first aspect of the invention.

According to a second aspect of the invention, there is provided an electrochemical cell, which includes a cell housing, a cathode, an anode and an electrolyte in the cell housing, in which the cathode is electronically insulated from the anode but electrochemically coupled thereto by the electrolyte, the cathode comprising a nickel-doped lithium-manganese-oxide spinel material produced by means of a microwave-assisted solid state reaction process.

The nickel-doped lithium-manganese-oxide spinel material may be that produced by the process of the first aspect of the invention.

The anode may comprise lithium (Li).

Any suitable electrolyte may be used, e.g. LiPF₆, optionally admixed with ethylene carbonate and/or dimethylcarbonate.

According to a third aspect of the invention, there is provided a method of making an electrochemical cell, which includes loading, into a cell housing, an electrolyte, an anode and cathode, with the cathode comprising a nickel-doped lithium-manganese-oxide spinel material produced by means of a microwave-assisted solid state reaction process.

The nickel-doped lithium-manganese-oxide spinel material may be that produced by the process of the first aspect of the invention.

According to a fourth aspect of the invention, there is provided a method of operating an electrochemical cell, which method includes
applying a charging potential to the electrochemical cell of the second aspect of the invention, thereby causing lithium from the cathode to form at least part of the anode; and
permitting the discharging potential of the cell to reach 3.5 to 4.3 V vs, lithium metal, and with the average manganese valence state being about 3.5+ or higher during charge and discharge of the cell.

The discharge potential may be permitted to reach 3.8 to 4.2 vs lithium.

The method may include subjecting the cell to a number of charging/discharging cycles, with each cycle comprising applying both the charging potential as hereinbefore described and the discharging potential as hereinbefore described.

The number of such cycles to which the cell is subjected may be at least 50, and typically at least 100, while maintaining at least 80% of its initial capacity, even at an elevated operating temperature, such as at about 60° C.

The invention will now be described in more detail with reference to the accompanying drawings and the following non-limiting examples.

In the drawings

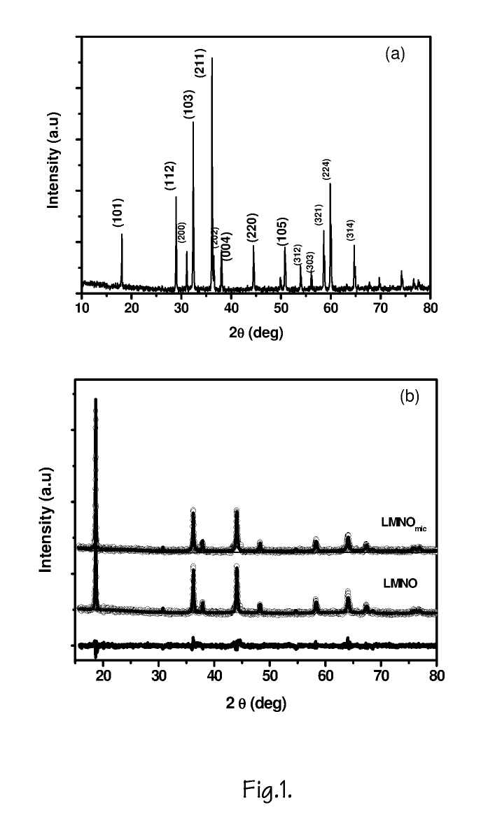

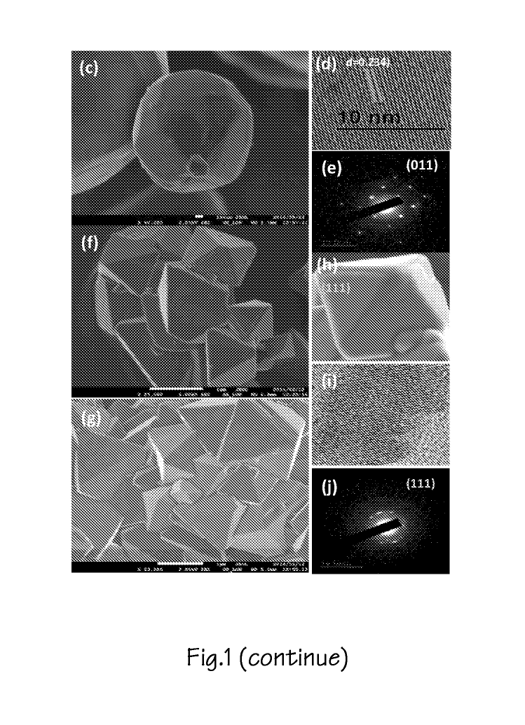

FIG. 1 shows, for the Example, structural characterization of Mn₃O₄, LMNO and LMNO_{mic}: (a) XRD profile of Mn₃O₄, (b) and (c) SEM and HRTEM images of Mn₃O₄ with corresponding SAED pattern, (d) and (e) XRD pattern of LMNO and LMNO_{mic} with Rietveld refinement, (f) and (g) SEM images of LMNO and LMNO_{mic}, (h) single nano-octahedron of LMNO, and ((i) and (j)) d-spacing of LMNO with the corresponding SAED pattern;

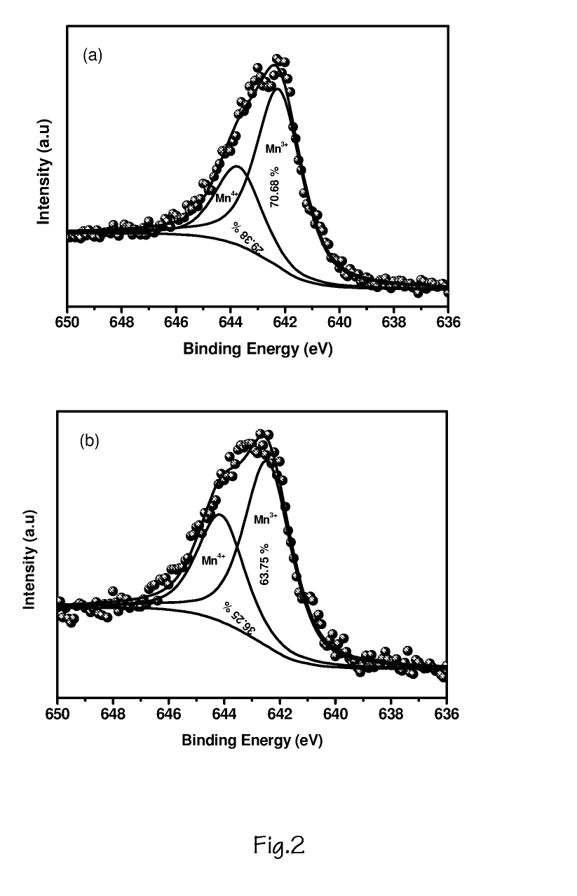

FIG. 2 shows, for the Example, XPS spectra obtained for (a) LMNO and (b) LMNO_{mic};

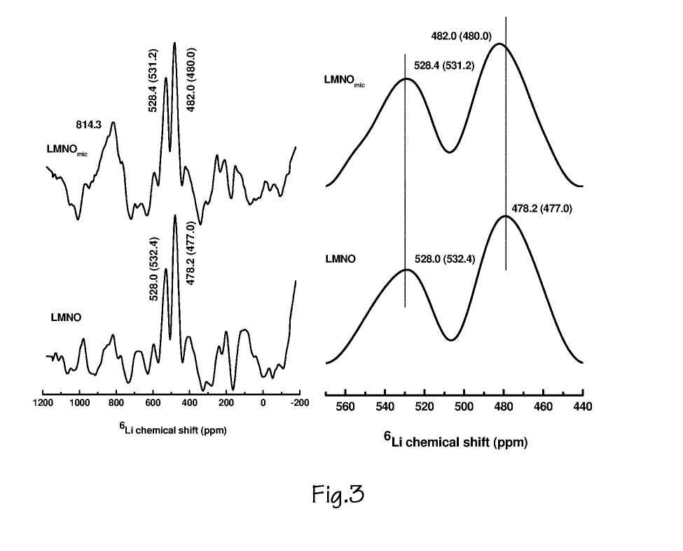

FIG. 3 shows, for the Example, ⁶Li MAS NMR spectra of LMNO and LMNO_{mic}, with an expanded view of 560-440 ppm;

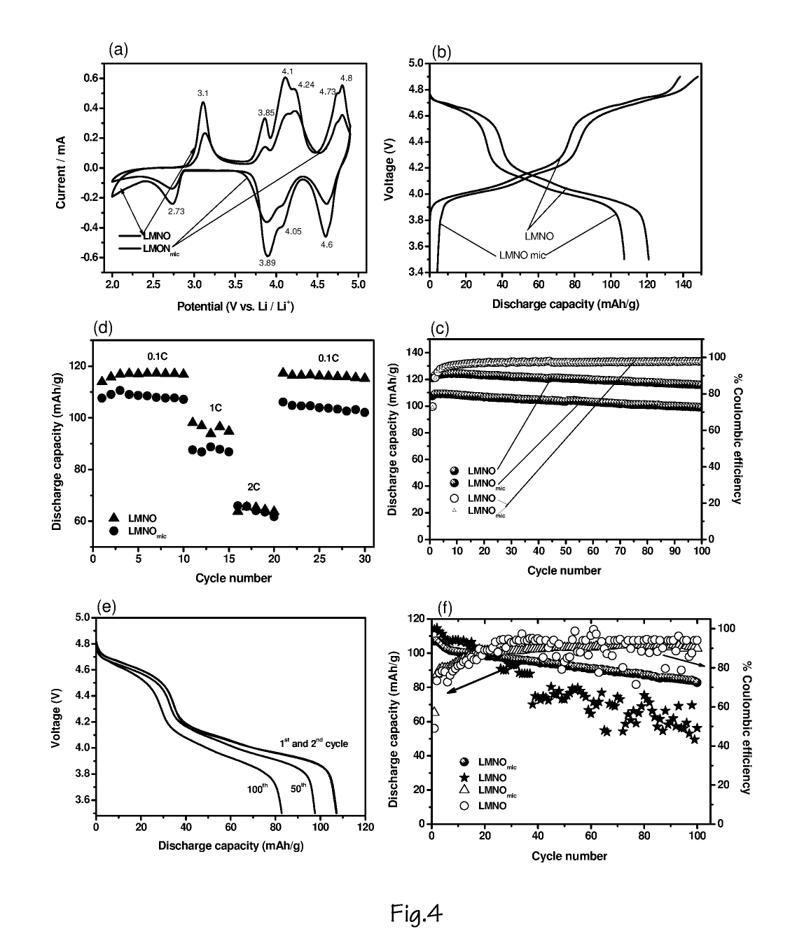

FIG. 4 shows, for the Example, electrochemical analysis of LMNO and LMNO_{mic} at room temperature and at 60° C.: (a) cyclic voltammetry at a scan rate of 1 mVs⁻¹, (b) charge-discharge at a current density of 0.1C, (c) prolonged cycling with coulombic efficiency at room temperature at a current density of 0.1C, (d) rate capability at different current densities, (e) discharge curves of LMNO_{mic} with current density of 0.1C at 60° C., and (f) prolonged cycling of LMNO_{mic} with coulombic efficiency at a current density of 0.1C at 60° C.; and

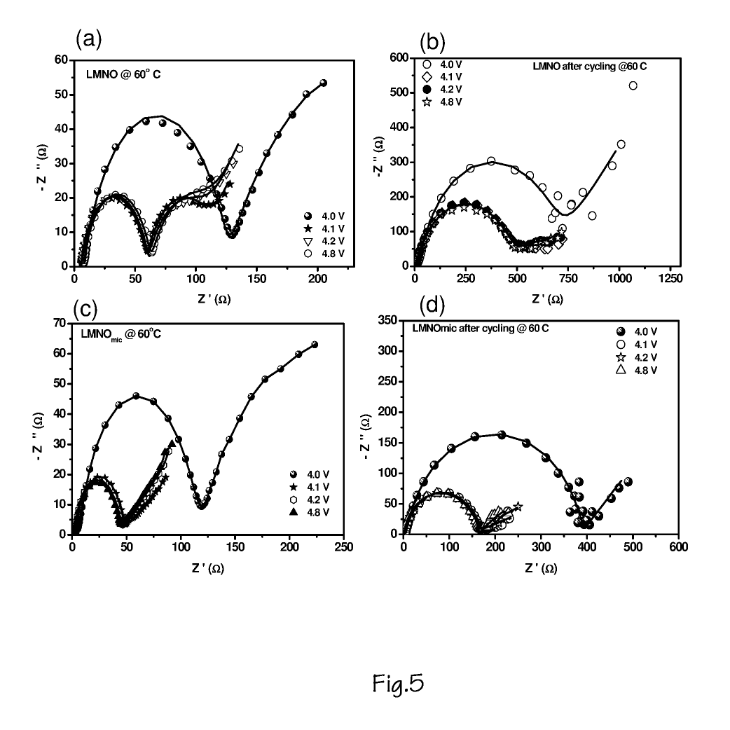

FIG. 5 shows, for the Example, electrochemical impedance spectra of LMNO and LMNO_{mic} at different voltage ranges before (a) and (c) and after ((b) and (d)) 50 cycles at 60° C.

### EXAMPLE

Experimental

Reagents and Synthesis of LMNO and LMNO_{mic}

First, the manganese precursor material (Mn₃O₄) was obtained from electrolytic manganese dioxide (MnO₂=92.46% purity, Delta EMD (Pty) Ltd, South Africa) by using the established method of high-temperature annealing at 1050° C. in air for 74 h, as descried in Komaba et al.¹ The purity and morphology of the Mn₃O₄ were established from SEM, TEM and XRD. NiO (>99% pure), Li₂CO₃ (>99% pure) and urea (>99% pure) were obtained from the Sigma-Aldrich and used without further treatment. The LiNi_{0.2}Mn_{1.8}O₄ (LMNO) was synthesized using a similar method to that of Yang et al.² In brief, stoichiometric amount of reagents Li₂CO₃, NiO and the as-prepared Mn₃O₄ (molar ratio of Li:Mn:Ni=1.15:1.8:0.2) were ground using a mortar and pestle. A 10% excess of Li₂CO₃ was used to compensate for the easy loss of Li at high temperature heating. Urea (0.57 M per lithium) was added to the mixture and then ground to fine powder. The mixture was thereafter preheated at 500° C. for about 7 min. Upon cooling down to room temperature in air, the preheated spinel precursor was ground into fine powder and then divided into two equal portions; the first portion was directly annealed at 900° C. for 6 h, while the second portion was subjected to microwave irradiation at 600 W for 20 min (using the Anton Paar Multiwave 3000 system, λ=0.12236 m) before annealing at 900° C. for 6 h. The spinel materials without and with microwave irradiation are abbreviated herein as LMNO and LMNO_{mic}, respectively.

Characterization Techniques

The XRD patterns of the as-prepared Mn₃O₄, LMNO and LMNO_{mic} were obtained from PANalytical X'Pert PRO diffractometer equipped with Ni-filtered Cu K-alpha radiation (λ=1.541841 A). X-ray Photoelectron Spectroscopy (XPS) was performed for LMNO and LMNO_{mic} using a non-monochromatic aluminium (Al) Kα source (1486.6 eV) and an Al monochromatic Kα source (1486.6 eV), respectively. The XPS data analysis was performed with the XPS Peak 4.1 program and a Shirley function was used to subtract the background. The morphology of the as-synthesized powders was analysed using JEOL-JSM 7500F scanning electron microscope operated at 2.0 kV. TEM and HRTEM images were obtained from JEOL-Jem 2100 microscope operated at an acceleration voltage of 200 kV. All the NMR experiments were performed on a Bruker Avance 500 MHz (B0=11.7 Tesla) Wide bore spectrometer. ⁶Li and ⁷Li NMR measurements were done at corresponding Larmor frequencies of 73.59 and 194.36 MHz respectively using a 3.2 mm CPMAS probe. ⁶Li NMR was collected using a rotor synchronized Hahn echo sequence (90-tau-180-tau acquisition) at 20 kHz spinning speed. 90° pulse lengths of 6 μs and a relaxation delay of 0.5 s was used. ⁷Li NMR was collected using a single pulse at MAS rates of 17, 20, 23 kHz for identifying the center bands. 2 μs pulse was used for excitation (90° pulse was 4.6 μs) and a relaxation delay of 0.5 s was used. All the spectra were referenced to standard 1 M LiCl solution at 0 ppm. All the electrochemical analyses were carried out in a coin cell (LIR-2032) fabricated with as-prepared LMNO and LMNO_{mic} as the positive electrodes and lithium metal foil as the negative using a MACCOR series 4000 tester. The positive electrodes were prepared by coating the slurry mixture of the electrode material, acetylene black and polyvinylidene fluoride (80:10:10) onto a cleaned and polished aluminium foil, and dried in a vacuum oven at 80° C. overnight. The cells were assembled in an argon-filled MBraun® glovebox (O₂, H₂O<0.5 ppm). The electrolyte was 1 M LiPF₆ in a mixture of 1:1 (v/v) ethylene carbonate (EC)/dimethyl carbonate (DMC) while Cellgard 2300 was used as the separator. The cyclic voltammetry (CV) and electrochemical impedance (EIS) analysis were carried out on a Bio-Logic VMP3 Potentiostat/Galvanostat controlled by EC-Lab v10.40 software.

Results and Discussion

FIG. 1a shows the XRD pattern of the as-prepared Mn₃O₄ with peaks that can be indexed to the tetragonal Mn₃O₄ spinel (JCPDS no: 80-0382) with space group I4₁/amd. The obtained well-defined reflections with no impurity phases indicate that the as-prepared Mn₃O₄ is highly crystalline.

FIG. 1b shows the XRD profiles of LMNO and LMNO_{mic} with their Rietveld refinement. This confirms that the prepared materials have typical single phase spinel structures, which adopt the Fd-3m space group with lithium and transition metals located in 8a and 16d sites respectively. The calculated lattice parameters of the pristine (a=8.211 Å) and microwave treated (a=8.213 Å) are essentially the same and are in agreement with literature.³

FIG. 1c depicts the SEM image of Mn₃O₄, and the lattice fringes (FIG. 1d) with its corresponding selected area diffraction, SAED pattern (FIG. 1e). It is clearly seen from the figures that the as-prepared Mn₃O₄ exhibits tetragonally-distorted spinel morphology in micron size. From HRTEM image of lattice fringes, it has an average neighbouring fringes with distance of 0.234 nm, corresponding to the {011} facets. This is also confirmed by using SAED pattern. FIGS. 1f and g show the SEM images of LMNO and LMNO_{mic}, magnified view of one well-defined octahedron particle display {111} facets (FIG. 1h) and the HRTEM image of lattice fringe of LMNO with corresponding SAED pattern (FIGS. 1i and j). As can be seen from the figures, LMNO and LMNO_{mic} exhibit the distinct morphology of octahedron with well-resolved lattice fringes (FIG. 1i) and the spacing between the adjacent fringes was measured to be 0.25 nm corresponding to d-spacing of (111) direction (FIG. 1 j). As displayed by the HRTEM images, clear lattice fringes and diffraction spots of LMNO and LMNO_{mic} expose the {111} facets with single crystalline octahedron. EDX confirmed the stoichiometry of LMNO and LMNO_{mic} as LiMn_{1.8}Ni_{0.2}O₄.

FIG. 2 compares the XPS of deconvoluted Mn 2p_{3/2} peaks of the LMNO and LMNO_{mic} samples. Each of the deconvoluted spectra gives two binding energy values corresponding to the characteristic peaks of Mn³⁺/Mn⁴⁺ at 642.17/643.59 and 642.43/644.12 eV, and the values are very close in accordance with reported values. The Ni 2p peak could not be viewed owing to its low intensity as a result from the low Ni content in the samples. Table 1 summarizes the XPS data, including the ratio of Mn³⁺/Mn⁴⁺ and manganese valence of the LMNO and LMNO_{mic}.

TABLE 1
XPS (Mn-2p3/2 spectra) data of the LMNO and LMNO samples

| | | | Cation | | | |
|---|---|---|---|---|---|---|
| | Binding energy | | distribution | | | Mn Valence |
| | position (eV) | | Mn⁴⁺ | Mn³⁺ | | (average |
| Sample | Mn⁴⁺ | Mn³⁺ | (%) | (%) | Mn³⁺/Mn⁴⁺ | redox state) |
| LMNO | 643.59 | 642.17 | 29.32 | 70.68 | 2.41 | 3.293 |
| LMNO_{mic} | 644.12 | 642.43 | 36.25 | 63.75 | 1.75 | 3.363 |

From the XPS data in Table 1, the LMNO_{mic} contains more of the Mn³⁺ in its structure than in the LMNO. Evidently, microwave irradiation was able to tune the ratio of the Mn³⁺/Mn⁴⁺ from 2.41 (for LMNO) to 1.75 (for LMNO_{mic}), with the manganese average redox state (Mn valence) being 3.29 and 3.36 for LMNO and LMNO_{mic}, respectively.

Solid-state ⁶Li Magic Angle Spinning Nuclear Magnetic Resonance (MAS-NMR) spectroscopy is highly sensitive to the local environment of the Li ion. ⁶Li MAS-NMR analyses were performed on LMNO and LMNO_{mic} in order to investigate the effect of microwave irradiation on the local environment of Li ions. FIG. 3 illustrates the ⁶Li MAS-NMR spectra of LMNO and LMNO_{mic} that were recorded at spinning speed of 20 kHz. The dominant interactions between Li nuclear spins and Mn electron spins are either through-bond (Fermi-contact) or through-space (dipolar) interactions. Fermi-contact interactions shift Li NMR resonances to >500 ppm, whereas the electron-nuclear dipolar interactions give raise to large spinning sideband patterns during MAS-NMR. For instance, the spinel LiMn₂O₄ gives major resonance of Li nuclei around ^{˜}520 ppm corresponding to the mixed-valence of Mn³⁺ and Mn⁴⁺ ions (average oxidation state of Mn^{3.5+}, i.e., cation distribution is 50% Mn³⁺ and 50% Mn⁴⁺). If the average oxidation state of Mn (i.e., Mn valence) around the local lithium site is increased, then the lithium chemical shift moves further downfield of 520 ppm. This increase in oxidation state of manganese ions in the local environment of lithium, results in a shift of the resonance to higher frequency. As shown in FIG. 3, two major ⁶Li resonances are observed at 528.4 and 482.0 ppm for LMNO_{mic} and 528.0 and 478.2 ppm for LMNO, which can be assigned to the tetrahedrally coordinated Li⁺ surrounded by Ni²⁺ and Mn⁴⁺ ions. The slight shift of the peaks to the lower frequencies is attributed to the increased Mn³⁺ content in the LMNO. Importantly, the peaks in the high frequency region (750-850 pm) region are due to Mn⁴⁺, thus the broad high frequency resonance observed at 814.3 ppm for the LMNO_{mic} clearly indicates that the microwave irradiation causes further increase in Mn⁴⁺ concentration around Li⁺ which, in turn, results in the chemical shift of lithium resonance moving further downfield. Indeed, the ⁶Li MAS-NMR spectra clearly corroborate the XPS and XRD results that predict higher concentration of the Mn³⁺ in the LMNO than in the LMNO_{mic} spinel structure.

Cyclic voltammetry (CV) studies were performed on LMNO and LMNO_{mic} at room temperature at a scan rate of 0.1 mVs⁻¹ in order to investigate the diffusion kinetics of lithium. FIG. 4 a illustrates the CV profiles of LMNO and LMNO_{mic} recorded in the potential window of 2 to 4.9V vs Li/Li⁺ that display very prominent anodic and cathodic peaks corresponding to the lithium extraction and insertion kinetics. The well-resolved pair of anodic peaks at 4.73 and 4.8 and their corresponding cathodic peaks at 4.6 and 4.7 V are related with the oxidation of Ni²⁺/Ni³⁺ and Ni³⁺/Ni⁴⁺ as well as Li extraction/insertion processes. Similarly, the shoulder peaks observed for both anodic (4.12 and 4.24V) and cathodic (3.89 and 4.05 V) regions are characteristic of Mn³⁺/Mn⁴⁺ redox reactions despite having a small difference in cathodic peaks (3.87 and 4.06 V) for the microwave irradiated sample. It is noteworthy to mention that the anodic peak obtained at 3.85V associated with the extraction of lithium resides at the octahedral sites. The peak intensity increases while increase in cycling as a result of an incomplete extraction of lithium that occupies the octahedral sites at 3.12 V. In addition, the strong peaks resolved at 3.1V for anodic and 2.73 V for cathodic infer that the intercalation of lithium is more pronounced even below 3V, the sharp peaks indicate that the as-prepared spinel has substantial stability even below 3V.

FIG. 4 (b) compares the galvanostatic charge-discharge of LMNO and LMNO_{mic} samples at room temperature. The curves are typical signatures of LiMn_{1.8}Ni_{0.2}O₄. The well-defined plateaus around 4.73, 4.12 and 4.05 V regions for both samples, confirm the redox reactions of Ni and Mn. The pristine and microwave irradiated samples delivered comparable specific capacities of 121 and 108 mAh/g at room temperature, respectively. Both samples retained more than 95% of their initial capacity after 100 cycles and maintained excellent coulombic efficiency (FIG. 4c). FIG. 4d showed that both samples showed comparable rate capability, especially at 2C. At elevated temperature of 60° C. (FIGS. 4 e & f), the LMNO_{mic} outperformed than the pristine LMNO-based cell, with a specific capacity of 108 mAh/g and good cycling stability, retained ^{˜}80% of its initial capacity with 90% coulombic efficiency after 100 repeated cycles). The LMNO delivered an initial capacity of 118 mAh/g at 60° C. but the cycling stability is very poor, retaining about 40% of its initial capacity after 100 cycles. At room temperature, both LMNO and LMNO_{mic} underwent almost similar electrochemical performances in terms of specific capacity and capacity retention. The microwave-treated spinel with slightly higher average Mn redox state exhibited good cycle stability at 60° C. than the pristine LMNO. It can be concluded that the high capacity retention of the LMNO_{mic} at elevated temperature is due to the ability of the microwave irradiation to tune the Mn valence or the Mn³⁺/Mn⁴⁺ ratio to an appropriate level for enhanced electrochemical performance. The poor performance of the LMNO at 60° C. may be related to its higher Mn³⁺ content which may be taking part in the disproportionation reaction. Despite that both spinel materials have same surface {111} facets, the slightly higher content of Mn³⁺ in pristine may still allow the disproportionation reaction to occur.

To provide further insights into the effects of microwave-treatment on the spinel materials, EIS experiments were carried out on LMNO- and LMNO_{mic}-based coin cells at different voltages after the freshly prepared cells were relaxed at OCV for 1 h. FIG. 5a-f illustrate the Nyquist plots of LMNO and LMNO_{mic} obtained before and after 50 charge-discharge cycles at 60° C. All the obtained EIS curves were satisfactorily fitted with an electrical equivalent circuit shown in FIG. 5a (inset). The fitting parameters consist of depressed semicircle at high and intermediate frequency domain related to the solid-electrolyte interface (SEI) whose resistance is denoted as R_{f}, constant-phase element of surface film (CPE_{f}), interfacial capacitance (CPE_{Li}), the solution bulk resistance (R₅), the charge transfer resistance of lithium insertion and extraction (R_{ct}), the Warburg impedance (Z_{w}) due to the lithium-ion diffusion in the solid state. As seen in FIG. 5a-d, the formation of SEI layer becomes more stable for LMNO_{mic} at all voltage range at the elevated temperature after 50 consecutive charge-discharge cycles, which results in the appearance of high frequency semicircle at all potentials investigated. The thin SEI layer formed may be due to the octahedral shaped particles with {111} facets suppressing the co-insertion of electrolyte and delivered larger lithium diffusion. Tables 2 and 3 summarise the values from the fitted Nyquist plots using the EEC for the LMNO and LMNO_{mic}, respectively. From FIG. 5 and Tables 2 and 3, it is evident that the poor cycling performance of the LMNO at elevated temperature may be related to systematic rise in impedance arising from the Mn³⁺ dissolution.

TABLE 2
Summary of EIS parameters for the LMNO based coin cells; all values were obtained from the fitted impedance
spectra after several iterations using the proposed equivalent electrical circuit shown in FIG. 5.

| Applied | EIS data for LMNO @ 60° C. | | | | | | |
|---|---|---|---|---|---|---|---|
| potential | | | | | | | Zw |
| (V) | Rₛ(Ω) | R_{f}(Ω) | CPE(μF) | n | C_{Li} (mF) | R_{Li} (Ω) | (Ω · ω^{-1/2}) |

Before cycling

| | | | | | | | |
|---|---|---|---|---|---|---|---|
| 4.0 | 8.25 ± 0.43 | 49.51 ± 6.48 | 25.93 ± 2.02 | 0.72 ± 0.14 | 13.7 ± 1.8 | 120 ± 1.26 | 20.36 ± 0.8 |
| 4.1 | 7.78 ± 0.52 | 41.84 ± 6.86 | 17.44 ± 0.75 | 0.73 ± 0.05 | 14.53 ± 5.76 | 54.64 ± 1.8 | 8.10 ± 0.97 |
| 4.2 | 6.05 ± 0.45 | 54.53 ± 2.06 | 15.79 ± 6.59 | 0.72 ± 0.18 | 11.6 ± 0.76 | 49.77 ± 3.64 | 6.94 ± 0.86 |
| 4.8 | 5.54 ± 0.45 | 54.08 ± 2 | 17.08 ± 7.09 | 0.78 ± 0.21 | 9.51 ± 0.43 | 51.67 ± 2.49 | 5.22 ± 0.78 |

After 50^{th} cycle

| | | | | | | | |
|---|---|---|---|---|---|---|---|
| 4.0 | 11.14 ± 0.57 | 762 ± 2.54 | 8.13 ± 0.42 | 0.72 ± 0.24 | 17.24 ± 1.42 | 236 ± 5.74 | 34.21 ± 1.24 |
| 4.1 | 6.35 ± 0.84 | 531 ± 6.47 | 6.42 ± 0.74 | 0.67 ± 0.17 | 11.9 ± 1.34 | 241 ± 3.14 | 28.87 ± 3.72 |
| 4.2 | 2.62 ± 0.65 | 514.8 ± 15.37 | 1.35 ± 0.28 | 0.68 ± 0.51 | 10.08 ± 1.04 | 383.2 ± 17.17 | 47.55 ± 0.78 |
| 4.8 | 5.43 ± 0.53 | 548.7 ± 19.73 | 5.92 ± 0.48 | 0.75 ± 0.57 | 1.41 ± 0.26 | 260 ± 3.62 | 36.98 ± 2.53 |

TABLE 3
Summary of EIS parameters for the LMNO_{mic}-based coin cells; all values were obtained from the fitted impedance
spectra after several iterations using the proposed equivalent electrical circuit shown in FIG. 5.

| Applied | EIS data for LMNO-mic @ 60° C. | | | | | | |
|---|---|---|---|---|---|---|---|
| potential | | | | | | | Zw |
| (V) | Rₛ(Ω) | R_{f}(Ω) | CPE(μF) | n | C_{Li} (mF) | R_{Li} (Ω) | (Ω · ω^{-1/2}) |

Before cycling

| | | | | | | | |
|---|---|---|---|---|---|---|---|
| 4.0 | 2.76 ± 0.34 | 11.15 ± 2.63 | 9.58 ± 0.45 | 0.72 ± 0.03 | 9.69 ± 0.9 | 46.51 ± 2.53 | 6.27 ± 2.62 |
| 4.1 | 2.58 ± 0.41 | 20.58 ± 3.57 | 9.37 ± 6.4 | 0.67 ± 0.13 | 25.5 ± 5.4 | 46.46 ± 3.91 | 10.07 ± 0.7 |
| 4.2 | 2.59 ± 0.39 | 17.13 ± 1.7 | 33.56 ± 18.05 | 0.52 ± 0.07 | 9.16 ± 6.6 | 42.46 ± 3.77 | 7.2 ± 2.4 |
| 4.8 | 5.15 ± 0.42 | 132.3 ± 20.6 | 12.41 ± 0.47 | 0.72 ± 0.15 | 11.44 ± 1.94 | 114 ± 1.68 | 12.97 ± 1.44 |

After 50^{th} cycle

| | | | | | | | |
|---|---|---|---|---|---|---|---|
| 4.0 | 4.13 ± 0.48 | 409.3 ± 2.23 | 9.74 ± 0.68 | 0.63 ± 0.05 | 5.44 ± 0.26 | 272.3 ± 9.42 | 51.66 ± 13.19 |
| 4.1 | 3.86 ± 0.21 | 173.35 ± 2.54 | 10.23 ± 0.57 | 0.61 ± 0.18 | 3.63 ± 0.38 | 94.68 ± 2.81 | 32.24 ± 5.34 |
| 4.2 | 2.17 ± 0.34 | 164.71 ± 1.72 | 8.71 ± 1.73 | 0.64 ± 0.13 | 7.11 ± 1.53 | 105.41 ± 5.26 | 29.89 ± 2.71 |
| 4.8 | 1.86 ± 0.51 | 179.43 ± 2.78 | 9.18 ± 0.82 | 0.69 ± 0.57 | 4.69 ± 0.86 | 96.82 ± 2.37 | 36.22 ± 4.39 |

Lithium diffusion coefficients (D_{Li}) of the LMNO- and LMNO_{mic}-based coin cells were determined before and after 50 consecutive cycles at 25° C. and 60° C. respectively by using equation (eq. 1) with Warburg impedance, a, obtained from the slope of real impedance (Z′) vs reciprocal square root of frequency (ω^{-1/2}) in the low frequency region.⁴

$$\begin{matrix}{D}_{Li} = \frac{2 {R}^{2} {T}^{2}}{{n}^{4} {F}^{4} {σ}^{2} {A}^{2} {C}_{Li}^{2}} & ( 1 ) \\ {Z}_{ω} = σ ( 1 - j ) {ω}^{- 1 / 2} & ( 2 )\end{matrix}$$

where R is the gas constant, T is the absolute temperature, n is the number of electrons transferred per molecule during oxidation, F is the Faraday constant, C_{Li} is the lithium concentration in the cathode material and A is the geometric surface area of the cathode. The diffusion coefficients calculated at 4.2 V are found to be 3.32×10⁻¹³, 1.6×10⁻¹², 2.8×10⁻¹² and 5.1×10⁻¹² cm² s⁻¹ at room temperature for LMNO, LMNO_{mic} and their respective values after 50 charge-discharge cycles and the obtained values are in accordance with the values reported in the literature.⁵ At 60° C., the spinel revealed the D_{Li} of 2.03×10⁻¹² and 7.93×10⁻¹² cm² s⁻¹ for LMNO and LMNO_{mic} respectively, and 1.38×10⁻¹³ and 3.19×10⁻¹² cm² s⁻¹ for LMNO and LMNO_{mic} after 50 repeated cycles, respectively. As expected that the microwave treated spinel have high diffusion coefficients even after prolonged cycling than the pristine.

### CONCLUSION

It was thus found that microwave irradiation on LMO chemistry along with small amounts of nickel doping improved the electrochemical performance of the spinel material at elevated temperature; microwave irradiation was confirmed as an essential step to achieve enhanced LMO electrochemistry. In addition, the ^{6,7}Li MAS NMR shows the two isotropic Li resonance for LMNO and LMNO-mic resulting in the additional peak at high frequency region which indicates the different Li environments by the distribution of Mn and Ni atoms. Spinel exposed most active {111} facets restricts the formation of thick SEI layers and improved the lithium diffusion. However, the existence of both Mn³⁺ with more Mn⁴⁺ concentration with active surface facets in the microwave irradiated spinel delivered a better cycle stability, low impedance, and improved lithium diffusivity at different temperatures compared to the untreated one.

The well-established poor electrochemical cycling performance of the LiMn₂O₄ (LMO) spinel cathode material for lithium-ion batteries at elevated temperature stems from the instability of the Mn³⁺ concentration. Microwave-assisted solid-state reaction has been used to dope LMO with a very low amount of nickel (i.e., LiNi_{0.2}Mn_{1.8}O₄, or LMNO) for a lithium-ion battery using Mn₃O₄ prepared from electrolytic manganese oxide (EMD, γ-MnO₂). To establish the impact of microwave irradiation on the electrochemical cycling performance at elevated temperature (60° C.), the Mn³⁺ concentration in the pristine and microwave-treated LMNO samples was independently confirmed by XRD, XPS, ⁶LiMAS-NMR and electrochemical studies including electrochemical impedance spectroscopy (EIS). The microwave-treated sample (LMNO_{mic}) allowed for the clear exposure of the {111} facets of the spinel, optimized the Mn³⁺ content, promoting structural and cycle stability at elevated temperature. At room temperature, both the pristine (LMNO) and microwave-treated (LMNO_{mic}) samples gave comparable cycling performance (>96% capacity retention and ca. 100% coulombic efficiency after 100 consecutive cycling). However, at elevated temperature (60° C.), the LMNO_{mic} gave an improved cycling stability (>80% capacity retention and ca. 90% coulombic efficiency after 100 consecutive cycling) compared to the LMNO. For the first time, the impact of microwave irradiation on tuning the average manganese redox state of the spinel material to enhance the cycling performance of the LiNi_{0.2}Mn_{1.8}O₄ at elevated temperature and lithium-ion diffusion kinetics have been clearly demonstrated.

The preparation of nickel-doped LMO (i.e., LiNi_{0.2}Mn_{1.8}O₄) with microwave irradiation as an essential step to achieve enhanced electrochemistry has thus been demonstrated.

### REFERENCES

1. Komaba, S.; Tsuchikawa, T.; Ogata, A. Enhancement of Pseudo-capacitive Behaviors of Birnessite Type Manganese Dioxide by Electrolyte Additive. ECS Transactions, 2008, 16, 201-205.
2. Yang, K.; Su, J.; Zhang, L.; Long, Y.; Lv, X.; Wen, Y. Urea Combustion Synthesis of LiNi_{0.5}Mn_{1.5}O₄ as a Cathode Material for Lithium Ion Batteries. Particuology, 2012, 10, 765-770.
3. Manthiram, A.; Chemelewski, K. R.; Lee, E. S. A Perspective on the High-Voltage LiMn_{1.5}Ni_{0.5}O₄ Spinel Cathode for Lithium-Ion Batteries. Energy Environ. Sci., 2014, 7, 1339-1350.
4. Jafta, C. J.; Ozoemena, K. I.; Mathe, M. K.; Roos, W. D. Synthesis, Characterisation and Electrochemical Intercalation Kinetics of Nanostructured Aluminium-Doped Li [Li_{0.2}Mn_{0.54}Ni_{0.13}Co_{0.13}]O₂ Cathode Material for Lithium Ion Battery. Electrochim. Acta 2012, 85, 411-422.
5. Mohamedi, M.; Makino, M.; Dokko, K.; Itoh, T.; Uchida, I. Electrochemical Investigation of LiNi_{0.5}Mn_{1.5}O₄ Thin Film Intercalation Electrodes. Electrochim. Acta 2002, 48, 79-84.

1. A process for producing a doped lithium-manganese-oxide spinel material, which process includes
producing, by means of a solid-state reaction, a spinel precursor comprising lithium-manganese-oxide doped with nickel;
subjecting the precursor to microwave treatment, to obtain a treated precursor; and
annealing the treated precursor, to obtain a nickel-doped lithium-manganese-oxide spinel material.

2. The process according to claim 1, wherein the solid state reaction includes heating a mixture of a solid manganese precursor material, a solid nickel precursor material, a solid lithium precursor material and a fuel or reducing agent to an elevated temperature, and maintaining it at the elevated temperature for a period of time.

3. The process according to claim 2, wherein the solid manganese precursor material is an oxide, a hydroxide or a salt of manganese; the solid nickel precursor material is an oxide, a hydroxide or a salt of nickel; the solid lithium precursor material is an oxide, a hydroxide or a salt of lithium; and the fuel or reducing agent is urea, hydrazine, glycine, or a carbohydrate.

4. The process according to claim 2, wherein the elevated temperature to which the mixture is heated is at least 400° C.

5. The process according to claim 2, wherein the period of time for which the mixture is maintained at the elevated temperature is at least 5 minutes.

6. The process according to claim 1, wherein the microwave treatment comprises subjecting the precursor to microwaves for between 10 and 30 minutes.

7. The process according to claim 1, wherein the annealing of the treated precursor is effected at a temperature which is sufficiently high to crystallize the precursor.

8. The process according to claim 7, wherein the annealing is effected at a temperature of at least 700° C.

9. The process according to claim 1, wherein the lithium-manganese-oxide material is LiMn₂O₄ (‘LMO’), while the nickel-doped lithium-manganese-oxide material is LiMn_{1.8}Ni_{0.2}O₄ (‘LMNO’).

10. A nickel-doped lithium-manganese-oxide spinel material when produced by the process of claim 1.

11. An electrochemical cell, which includes a cell housing, a cathode, an anode and an electrolyte in the cell housing, in which the cathode is electronically insulated from the anode but electrochemically coupled thereto by the electrolyte, the cathode comprising a nickel-doped lithium-manganese-oxide spinel material produced by means of a microwave-assisted solid state reaction process, and the cell being capable of being subjected to at least 50 charging/discharging cycles at an elevated operating temperature, while maintaining at least 80% of its initial capacity.

12. The electrochemical cell according to claim 11, wherein the elevated operating temperature is about 60° C.

13. The electrochemical cell according to claim 11, wherein the nickel-doped lithium-manganese-oxide spinel material is produced by a process which process includes
producing, by means of a solid-state reaction, a spinel precursor comprising lithium-manganese-oxide doped with nickel;
subjecting the precursor to microwave treatment, to obtain a treated precursor; and
annealing the treated precursor, to obtain a nickel-doped lithium-manganese-oxide spinel material.

14. The electrochemical cell according to claim 11, wherein the anode comprises lithium (Li).

15. The electrochemical cell according to claim 11, wherein the electrolyte is LiPF₆, optionally admixed with ethylene carbonate and/or dimethylcarbonate.

16. A method of making an electrochemical cell, which includes loading, into a cell housing, an electrolyte, an anode and cathode, with the cathode comprising a nickel-doped lithium-manganese-oxide spinel material produced by means of a microwave-assisted solid state reaction process.

17. The method according to claim 16, wherein the nickel-doped lithium-manganese-oxide spinel material is produced by a process which process includes
producing, by means of a solid-state reaction, a spinel precursor comprising lithium-manganese-oxide doped with nickel;
subjecting the precursor to microwave treatment, to obtain a treated precursor; and
annealing the treated precursor, to obtain a nickel-doped lithium-manganese-oxide spinel material.

18. A method of operating an electrochemical cell, which method includes
applying a charging potential to the electrochemical cell of claim 11, thereby causing lithium from the cathode to form at least part of the anode;
permitting the discharging potential of the cell to reach 3.5 to 4.3 V vs lithium metal, and with the average manganese valence state being about 3.5+ or higher during charge and discharge of the cell; and
subjecting the cell to at least 50 charging/discharging cycles at an elevated operating temperature, with each cycle comprising applying both the charging potential and the discharging potential, while maintaining at least 80% of the cell's initial capacity.

19. The method according to claim 18, wherein the discharge potential is permitted to reach 3.8 to 4.2 V vs lithium metal.

20. The method according to claim 18, wherein the elevated operating temperature is about 60° C.
